(19) United States
(12) Patent Application Publication
(10) Pub. No.: US 2026/0291395 A1
(43) Pub. Date: Sep. 24, 2026

(54) CONTROLLER FOR POWER CONVERTER

(71) Applicant: Renesas Design (UK) Limited, Bourne End (GB)

(72) Inventors: Jun MIN, San Jose, CA (US); Kai WAN, San Jose, CA (US); Keyue SHAN, San Jose, CA (US); Guang FENG, Cupertino, CA (US); Yong LI, San Jose, CA (US)

(73) Assignee: Renesas Design (UK) Limited, Bourne End (GB)

(21) Appl. No.: 19/085,575

(22) Filed: Mar. 20, 2025

(51) Int. Cl. H02M 3/335

(52) U.S. Cl. CPC H02M 3/3353

(57) ABSTRACT

A controller for a power converter for receiving an input voltage at a primary side and generating an output voltage at a secondary side, the power converter including a first primary side switch configured to be switchable between an on state and an off state, a second primary side switch configured to be switchable between the on state and the off state, and an energy transfer element configured to transfer energy from the input voltage to the secondary side. The controller is configured to operate in a first control state and a second control state.

### FIELD

The present disclosure relates to a controller for a power converter.

### BACKGROUND

Electronic device consumers prefer universal fast chargers that can efficiently charge a wide range of devices instead having to carry multiple dedicated chargers for each device.

This demand presents several engineering challenges, such as:
Wide output voltage and power adaptability—The charger preferably supports varying voltage and power levels for different devices.
High power density—To maintain portability, the charger is preferably compact and lightweight.
Universal input compatibility (for example from 85 volts AC to 264 volts AC)—The charger preferably function reliably in different regions without requiring additional adapters.

Preferably, a next-generation fast charger can efficiently handle a wide input voltage range, support multiple output power levels, and maintain high power density while optimizing energy efficiency.

### SUMMARY

It is desirable to provide an improved power converter system that may be used for charging applications.

According to a first aspect of the disclosure there is provided a controller for a power converter for receiving an input voltage at a primary side and generating an output voltage at a secondary side, the power converter comprising a first primary side switch configured to be switchable between an on state and an off state, a second primary side switch configured to be switchable between the on state and the off state, and an energy transfer element configured to transfer energy from the input voltage to the secondary side, wherein the controller is configured to operate in a first control state, wherein the controller, whilst operating in the first control state, is configured to i) switch the first primary side switch to the on state for a first on time duration, and ii) switch each of the first and second primary side switches to the off state for a first off time duration, after the first on time duration, and operate in a second control state, wherein the controller, whilst operating in the second control state, is configured to i) switch the second primary side switch to the on state for a second on time duration, and ii) switch each of the first and second primary side switches to the off state for a second off time duration, after the second on time duration.

Optionally, the first control state is a first energy transfer state and the second control state is a reset state.

Optionally, the first primary side switch comprises a first primary transistor and/or the second primary side switch comprises a second primary transistor.

Optionally, at least one of the first primary transistor and the second primary transistor is a field effect transistor (FET), a bipolar junction transistor (BJT) or an insulated-gate bipolar transistor (IGBT).

Optionally, the first off time duration is greater than the first on time duration.

Optionally, the controller is configured to operate in an auxiliary control state, wherein the controller, whilst operating in the auxiliary control state, is configured to i) switch the first primary side switch to the on state for an auxiliary on time duration, and ii) switch each of the first and second primary side switches to the off state for an auxiliary off time duration, after the auxiliary on time duration, or i) switch an additional switch to the on state for the auxiliary on time duration, and ii) switch each of the first primary side switch, the second primary side switch and the additional switch to the off state for the auxiliary off time duration, after the auxiliary on time duration.

Optionally, whilst operating in the first control state, the controller is configured to switch each of the first primary side switch, the second primary side switch and the additional switch to the off state for the first off time duration, after the first on time duration, and whilst operating in the second control state, the controller is configured to switch each of the first primary side switch, the second primary side switch and the additional switch to the off state for the second off time duration, after the second on time duration.

Optionally, the auxiliary control state is a second energy transfer state.

Optionally, the controller is configured to apply a first control sequence by repeatedly cycling between i) operating in the first control state, ii) operating in the auxiliary control state, and iii) operating in the second control state.

Optionally, the controller is configured to, when applying the first control sequence i) transition from operating in the first control state to operating in the auxiliary control state, ii) transition from operating in the auxiliary control state to operating in the second control state, and iii) transition from operating in the second control state to operating in the first control state.

Optionally, the controller is configured to, when applying the first control sequence i) transition from operating in the first control state to operating in the auxiliary control state after the first off time duration has elapsed, ii) transition from operating in the auxiliary control state to operating in the second control state after the auxiliary off time duration has elapsed, and iii) transition from operating in the second control state to operating in the first control state after the second off time duration has elapsed.

Optionally, the controller is configured to apply a second control sequence by repeatedly cycling between i) operating in the first control state, and ii) operating in the second control state, and/or apply a third control sequence by repeatedly cycling between i) operating in the first control state, ii) operating in the auxiliary control state, and iii) repeatedly operating in the second control state for a plurality of second control state switching cycles, and/or apply a fourth control sequence by repeatedly cycling between i) operating in the first control state, ii) repeatedly operating in the auxiliary control state for a plurality of auxiliary control state switching cycles, and iii) operating in the second control state, wherein the controller is configured to switch between applying the first control sequence and one or more of the second, third and fourth control sequences.

Optionally, the controller is configured to when applying the second control sequence i) transition from operating in the first control state to operating in the second control state, and ii) transition from operating in the second control state to operating in the first control state, and/or when applying the third control sequence i) transition from operating in the first control state to operating in the auxiliary control state, ii) transition from operating in the auxiliary control state to operating in the second control state, and iii) transition from repeatedly operating in the second control state to operating in the first control state, and/or when applying the fourth control sequence i) transition from operating in the first control state to operating in the auxiliary control state, ii) transition from repeatedly operating in the auxiliary control state to operating in the second control state, and iii) transition from operating in the second control state to operating in the first control state.

Optionally, the controller is configured to when applying the second control sequence i) transition from operating in the first control state to operating in the second control state after the first off time duration has elapsed, and ii) transition from operating in the second control state to operating in the first control state after the second off time duration has elapsed, and/or when applying the third control sequence i) transition from operating in the first control state to operating in the auxiliary control state after the first off time duration has elapsed, ii) transition from operating in the auxiliary control state to operating in the second control state after the auxiliary off time duration has lapsed, and iii) transition from repeatedly operating in the second control state to operating in the first control state after the second off time duration of the last of the plurality of second control state switching cycles has elapsed, and/or when applying the fourth control sequence i) transition from operating in the first control state to operating in the auxiliary control state after the first off time duration has elapsed, ii) transition from repeatedly operating in the auxiliary control state to operating in the second control state after the auxiliary off time duration of the last of the plurality of auxiliary control state switching cycles has elapsed, and iii) transition from operating in the second control state to operating in the first control state after the second off time duration has elapsed.

Optionally, the controller is configured to apply the first control sequence when the power converter is operating in a discontinuous conduction mode (DCM), and/or apply the second control sequency when the power converter is operating in a continuous conduction mode (CCM) or a critical conduction mode (CRM).

Optionally, the first primary side switch and the second primary side switch are coupled at a first node, and the energy transfer element is coupled to the first node.

Optionally, the energy transfer element comprises a transformer comprising a primary winding and a secondary winding, the primary winding being coupled to the first node.

Optionally, the primary winding of the transformer is configured to, whilst the controller is operating in one of the first, second and auxiliary control states, exchange energy with an input source while simultaneously transferring energy to the secondary winding.

Optionally, the power converter comprises a resonant tank.

Optionally, the first primary side switch and the second primary side switch are coupled in series between a first voltage terminal for receiving the input voltage and a second voltage terminal for receiving a reference voltage.

Optionally, the controller comprises a first switch gate driver for providing a first gate drive signal to drive the switching operation of the first primary side switch and a second switch gate driver for providing a second gate drive signal to drive the switching operation of the second primary side switch.

Optionally, the controller comprises a first switch gate driver for providing a first gate drive signal to drive the switching operation of the first primary side switch, a second switch gate driver for providing a second gate drive signal to drive the switching operation of the second primary side switch, and an additional switch gate driver for providing an additional gate drive signal to drive the switching operation of the additional switch.

Optionally, the controller comprises a control core configured to provide a first control signal to the first switch gate driver, the first gate drive signal being dependent on the first control signal, and provide a second control signal to the second switch gate driver, the second gate drive signal being dependent on the second control signal.

Optionally, the controller comprises a control core configured to provide a first control signal to the first switch gate driver, the first gate drive signal being dependent on the first control signal, provide a second control signal to the second switch gate driver, the second gate drive signal being dependent on the second control signal, and provide an additional control signal to the additional switch gate driver, the additional gate drive signal being dependent on the additional control signal.

Optionally, the controller comprises a first control module comprising the first switch gate driver and the second switch gate driver, and a second control module comprising the additional switch gate driver.

Optionally, the first control module comprises a first control core configured to provide a first control signal to the first switch gate driver, the first gate drive signal being dependent on the first control signal, provide a second control signal to the second switch gate driver, the second gate drive signal being dependent on the second control signal, and a second control core configured to provide an additional control signal to the additional switch gate driver, the additional gate drive signal being dependent on the additional control signal.

Optionally, the control core comprises one or more of one or more logic circuits, an application specific integrated circuit (ASIC), and/or a processor.

Optionally, the control core is configured to sense one or more parameters of the power converter and to adjust the first and/or second control signals based on the sensed one or more parameters.

Optionally, the one or more parameters comprises the input voltage, the output voltage, and a node voltage at the first node.

Optionally, the controller is configured to operate in an auxiliary control state, wherein the controller, whilst operating in the auxiliary control state, is configured to i) switch the first primary side switch to the on state for an auxiliary on time duration, and ii) switch each of the first and second primary side switches to the off state for an auxiliary off time duration, after the auxiliary on time duration, apply a first control sequence by repeatedly cycling between i) operating in the first control state, ii) operating in the auxiliary control state, and iii) operating in the second control state.

Optionally, the controller is configured to apply the first control sequence by operating in an initial state prior to repeatedly cycling between operating in the first, auxiliary and second control states, wherein the initial state is one of the first, auxiliary and second control states and is dependent on one or more of the parameters as sensed by the control core.

Optionally, one of the one or more parameters is a node voltage at the first node, and the controller is configured to, when applying the first control sequence i) transition from operating in the auxiliary control state to operating in the second control state when the node voltage exceeds a maximum threshold value, and/or ii) transition from operating in the second control state to operating in the first control state when the node voltage falls below a minimum threshold value.

Optionally, the controller is configured to set, based on the one or more parameters sensed by the control core, one or more of the first on time duration, the first off time duration, the second on time duration, the second off time duration, the auxiliary on time duration, and the auxiliary off time duration.

Optionally, the energy transfer element comprises a transformer comprising a primary winding and a secondary winding, the primary winding being coupled to the first node, and the power converter comprises a resonant tank comprising one or more resonant tank capacitors.

Optionally, the controller comprises a first switch gate driver for providing a first gate drive signal to drive the switching operation of the first primary side switch, a second switch gate driver for providing a second gate drive signal to drive the switching operation of the second primary side switch, and a control core configured to provide a first control signal to the first switch gate driver, the first gate drive signal being dependent on the first control signal, and provide a second control signal to the second switch gate driver, the second gate drive signal being dependent on the second control signal, wherein the control core is configured to sense one or parameters of the power converter and to adjust the first and/or second control signals based on the sensed one or more parameters.

Optionally, the one or more parameters comprises the input voltage, the output voltage, a node voltage at the first node, a transformer primary side current, and a resonant tank capacitor voltage.

Optionally, the controller is configured to set the auxiliary on time duration based on one or more of the output voltage, the transformer primary side current and the resonant tank capacitor voltage.

Optionally, the controller comprises the additional switch, or the additional switch is external to the controller and the power converter, or the power converter comprises the additional switch.

Optionally, the first primary side switch and the second primary side switch are coupled at a first node, the energy transfer element comprises a transformer comprising a primary winding and a secondary winding, the primary winding being coupled to the first node, and the additional switch is coupled to the first node, or coupled to an auxiliary winding of the transformer on the primary side, or coupled to the primary winding of the transformer, or coupled to secondary winding of the transformer, or integrated in an isolated ground side.

Optionally, the power converter is a half bridge converter or a full bridge converter.

Optionally, the power converter is a forward-type half bridge converter.

Optionally, the power converter is a forward-type resonant half-bridge converter.

According to a second aspect of the disclosure there is provided a power converter system comprising a power converter for receiving an input voltage at a primary side and generating an output voltage at a secondary side, the power converter comprising a first primary side switch configured to be switchable between an on state and an off state, a second primary side switch configured to be switchable between the on state and the off state, and an energy transfer element configured to transfer energy from the input voltage to the secondary side, and a controller is configured to operate in a first control state, wherein the controller, whilst operating in the first control state, is configured to i) switch the first primary side switch to the on state for a first on time duration, and ii) switch each of the first and second primary side switches to the off state for a first off time duration, after the first on time duration, and operate in a second control state, wherein the controller, whilst operating in the second control state, is configured to i) switch the second primary side switch to the on state for a second on time duration, and ii) switch each of the first and second primary side switches to the off state for a second off time duration, after the second on time duration.

It will be appreciated that the power converter system of the second aspect may include features set out in relation to the first aspect and may include other features described herein, in accordance with the understanding of the skilled person.

According to a third aspect of the disclosure there is provided a method of controlling a power converter for receiving an input voltage at a primary side and generating an output voltage at a secondary side, the power converter comprising a first primary side switch configured to be switchable between an on state and an off state, a second primary side switch configured to be switchable between the on state and the off state, and an energy transfer element configured to transfer energy from the input voltage to the secondary side; the method comprising operating a controller in a first control state by i) switching the first primary side switch to the on state for a first on time duration, and ii) switching each of the first and second primary side switches to the off state for a first off time duration, after the first on time duration, and operating the controller in a second control state by i) switching the second primary side switch to the on state for a second on time duration, and ii) switching each of the first and second primary side switches to the off state for a second off time duration, after the second on time duration.

It will be appreciated that the method of the third aspect may include using and/or providing features set out in relation to the first aspect or the second aspect and may include using and/or providing other features as described herein.

### BRIEF DESCRIPTION OF THE DRAWINGS

The disclosure is described in further detail below by way of example and with reference to the accompanying drawings in which:

FIG. 1A is a schematic of a known active clamp flyback converter, FIG. 1B is a schematic of a known asymmetric half-bridge flyback converter;

FIG. 2A is a schematic of a known forward-type half-bridge converter, FIG. 2B is a schematic of a known forward-type zero-voltage switched multi-resonant converter (U.S. Pat. No. 4,857,822), FIG. 2C is a schematic of a known forward type multi-resonance power converter (O. Da Luz, E. Dupuy, M. Rocher, D. Sadarnac and M. Perelle, “Development of a 500 W/1 MHz resonant power supply,” Proceedings of Intelec 93: 15th International Telecommunications Energy Conference, Paris, France, 1993, pp. 140-145 vol. 1);

FIG. 3A is a schematic of a controller for a power converter in accordance with a first embodiment of the present disclosure, FIG. 3B is a schematic of a timing graph showing the switching states of the switches for an example operation of the controller and the power converter;

FIG. 4A is a schematic of a specific embodiment of the controller and power converter in accordance with a second embodiment of the present disclosure, FIG. 4B is a schematic of a specific embodiment of the controller as may be implemented in any of the embodiments described herein, FIG. 4C is a timing graph showing waveforms relating to a practical implementation of the controller and the power converter of FIG. 4A;

FIG. 5 is a schematic of an equivalent circuit of the forward type resonant half-bridge converter of FIG. 4A during resonance;

FIG. 6A is a flowchart outlining the three-state control method that transitions sequentially in a repeating cycle, FIG. 6B is a flowchart outlining the three state control method as provided by the controller for different control sequences;

FIG. 7A is a schematic of a specific implementation of the controller and the power converter in accordance with a third embodiment of the present disclosure, FIG. 7B is a schematic of a specific implementation of the power converter as may be used with any of the controller embodiments described herein, in accordance with a fourth embodiment of the present disclosure, FIG. 7C is a schematic of a specific implementation of the power converter as may be used with any of the controller embodiments described herein, in accordance with a fifth embodiment of the present disclosure, FIG. 7D is a schematic of a specific implementation of the power converter as may be used with any of the controller embodiments described herein, and in accordance with a sixth embodiment of the present disclosure, FIG. 7E is a schematic of a specific implementation of the power converter as may be used with any of the controller embodiments described herein, in accordance with a seventh embodiment of the present disclosure, FIG. 7F is a schematic of a specific implementation of the power converter as may be used with any of the controller embodiments described herein, in accordance with an eighth embodiment of the present disclosure, FIG. 7G is a schematic of a specific implementation of the power converter as may be used with any of the controller embodiments described herein, and in accordance with a ninth embodiment of the present disclosure, FIG. 7H is a schematic of a specific implementation of the power converter as may be used with any of the controller embodiments described herein, and in accordance with a tenth embodiment of the present disclosure, FIG. 7I is a schematic of a specific implementation of the power converter as may be used with any of the controller embodiments described herein, and in accordance with an eleventh embodiment of the present disclosure; and

FIG. 8A is a schematic of a specific implementation of the controller and the power converter in accordance with a twelfth embodiment of the present disclosure, FIG. 8B is a schematic of a specific implementation of the controller in accordance with a thirteenth embodiment of the disclosure, FIG. 8C is a schematic of a further specific implementation of the controller in accordance with a fourteenth embodiment of the disclosure, FIG. 8D is a flowchart outlining the three-state control method that transitions sequentially in a repeating cycle, FIG. 8E is a timing graph showing waveforms relating to a practical implementation of the controller and the power converter of FIG. 8A, FIG. 8F is a schematic of a specific implementation of the power converter as may be used with any of the controller embodiments described herein, and in accordance with a fifteenth embodiment of the present disclosure, FIG. 8G is a schematic of a specific implementation of the power converter as may be used with any of the controller embodiments described herein, and in accordance with a sixteenth embodiment of the present disclosure, FIG. 8H is a schematic of a specific implementation of the power converter as may be used with any of the controller embodiments described herein, and in accordance with a seventeenth embodiment of the present disclosure, FIG. 8I is a schematic of a specific implementation of the power converter as may be used with any of the controller embodiments described herein, and in accordance with an eighteenth embodiment of the present disclosure, FIG. 8J is a schematic of a specific implementation of the power converter as may be used with any of the controller embodiments described herein, and in accordance with a nineteenth embodiment of the present disclosure.

### DETAILED DESCRIPTION

Flyback converters are the dominant topology in fast chargers and power supplies due to their simplicity and ability to provide galvanic isolation. These converters operate by:
1. Receiving energy from input and storing energy in a transformer when the main switch is ON.
2. Transferring energy to the secondary side when the main switch is OFF.

However, this asynchronous energy reception/transfer (energy is received from the input and delivered to the secondary side at different times) leads to:
Large transformer size—Since the transformer must store energy, its core and winding design limit power density.
Lower efficiency—Energy storage and release introduce additional losses.

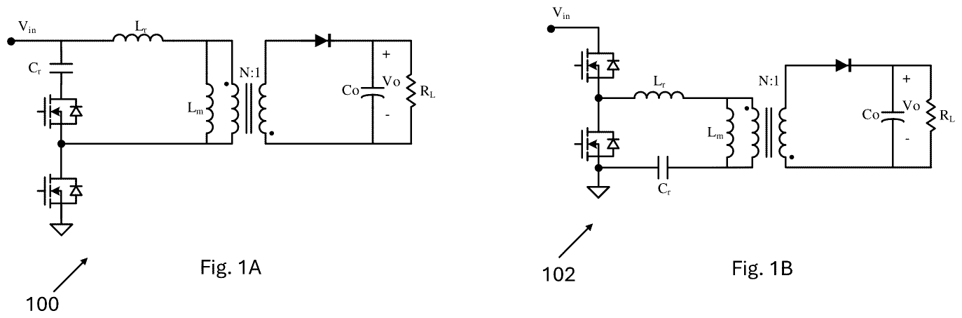

FIG. 1A is a schematic of a known active clamp flyback converter 100. FIG. 1B is a schematic of a known asymmetric half-bridge flyback converter 102. The flyback converters 100, 102 attempt to reduce transformer size and improve efficiency over other converters. However, these variants still use asynchronous energy reception/transfer, which fundamentally limits power density improvements.

Forward-type converters are an alternative to flyback converters. Forward-type converters transfer input energy to the secondary side synchronously, meaning that energy exchange from the input and energy delivery to the secondary side occur simultaneously. This reduces the need for significant energy storage and associated power losses, and thereby improves power density and efficiency.

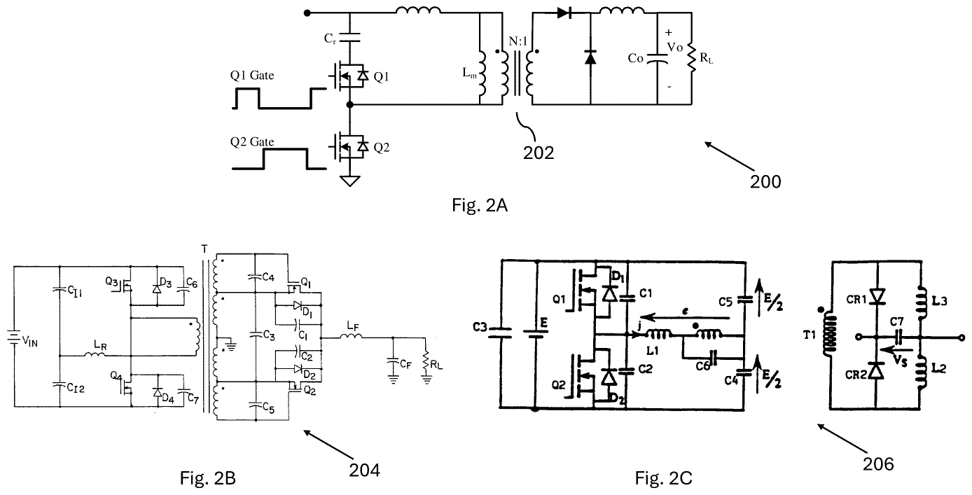

FIG. 2A is a schematic of a known forward-type half-bridge converter 200. The forward-type half bridge converter features two switches (a main switch Q2 and a reset switch Q1) that together form a half-bridge on the primary side of a transformer 202.

The gate signal waveforms for each of the switches Q1, Q2 are also shown in FIG. 2A, with a high signal denoting that the corresponding switch is on, and able to permit current flow, and a low signal denoting that the corresponding switch is off, and able to prevent current flow.

When the main switch Q2 is on, energy could be directly transferred to the secondary side. The reset switch Q1 is responsible for resetting the transformer winding, preventing core saturation.

A notable variation of the forward-type half-bridge converter is the resonant forward-type half-bridge converter, which enhances the standard topology by incorporating multiple resonant components, such as capacitors and inductors, into a resonant tank to achieve Zero Voltage Switching (ZVS).

FIG. 2B is a schematic of a known forward-type zero-voltage switched multi-resonant converter 204 (U.S. Pat. No. 4,857,822). FIG. 2C is a schematic of a known forward type multi-resonance power converter 206 (O. Da Luz, E. Dupuy, M. Rocher, D. Sadarnac and M. Perelle, “Development of a 500 W/1 MHz resonant power supply,” Proceedings of Intelec 93: 15th International Telecommunications Energy Conference, Paris, France, 1993, pp. 140-145 vol. 1).

These forward-type resonant half-bridge converters can be defined as follows: they comprise a first primary-side switch, a second primary-side switch, and a transformer coupled to the node between these switches; and in at least one operating state, the primary winding of the transformer exchanges energy with the input source while simultaneously transferring energy to the secondary winding.

Considering the forward type converters 204, 206 designs are based on a half-bridge structure combined with a resonant tank, this type of converter may be referred to as a “forward-type resonant half-bridge converter”.

Traditional switch control methods where the main switch and reset switch operate alternately (i.e., turning on the switch Q2, followed by turning on the switch Q1, then turning on the switch Q2 again, and repeating this sequence as shown in FIG. 2A) fail to guarantee ZVS for primary-side switches in various operating conditions.

ZVS is desirable for efficient power converter operation because turning on switches when the applied voltage is at or near zero minimizes power dissipation (since power loss is voltage×current). Without ZVS, switching losses increase, reducing efficiency and power density.

It is desirable to provide a forward-type resonant half-bridge converters for wide input/output voltage ranges and variable power levels with zero voltage switching (ZVS) for both primary-side switches during power transfer or transformer winding reset.

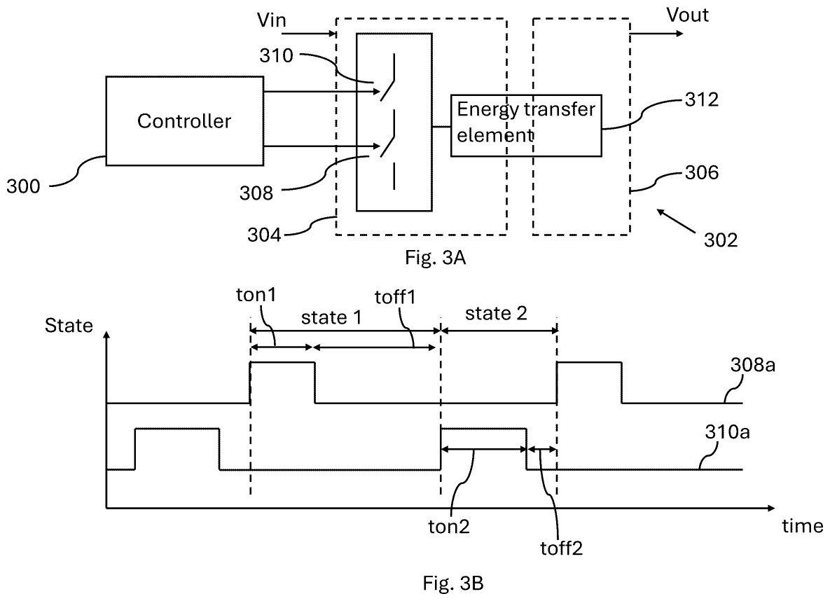

FIG. 3A is a schematic of a controller 300 for a power converter 302 in accordance with a first embodiment of the present disclosure. During operation, the power converter 302 receives an input voltage Vin at a primary side 304 and generates an output voltage Vout at a secondary side 306.

The controller 300 and the power converter 302 may form a power converter system.

The power converter 302 comprises primary side switches 308, 310, each being switchable between an on state and an off state. Whilst in the “on state”, a switch will permit current flow, and whilst in an “off state”, a switch will restrict current flow.

The term “turning on” a switch may refer to generating a control signal that controls the gate driver, causing the switch to establish a low-impedance connection (i.e., a resistance below a predefined threshold) between its terminals. Conversely, “turning off” a switch may refer to generating a control signal that controls the gate driver, causing a switch transitions into a state of electrical isolation, characterized by a resistance exceeding a predefined threshold, aside from minor leakage currents.

Each of the primary side switches 308, 310 may comprise a transistor, such as a field effect transistor (FET), a bipolar junction transistor (BJT) or an insulated-gate bipolar transistor (IGBT).

The power converter 302 further comprises an energy transfer element 312 which is configured to transfer energy from the input voltage Vin at the primary side 304 of the power converter 302, to the secondary side 306 of the power converter 302. The energy transfer element 312 may comprise a transformer.

During operation, the controller 300 acts to switch the states of the primary side switches 308, 310 in a manner that results in the transfer of energy from the input voltage Vin to the secondary side 306 via the energy transfer element 312 to generate the output voltage Vout.

The controller 300 is configured to operate in a first control state and a second control state. The first control state may be an energy transfer state, where the controller 300 operates the switches 308, 310 to transfer energy to the secondary side via the energy transfer element 312. The second control state may be a reset state, where the controller 300 operates the switches 308, 310 to reset the energy transfer element 312.

FIG. 3B is a schematic of a timing graph showing the switching states of the switches 308, 310 for an example operation of the controller 300 and the power converter 302.

A trace 308a shows the state of the primary side switch 308 and a trace 310a shows the state of the primary side switch 310. A high state denotes that the corresponding switch is in the on state and a low state denotes that the corresponding switch is in the off state.

In the first control state (labelled by “state 1”), the controller 300 is configured to switch the primary side switch 308 to the on state for a first on time duration ton1 and then switch each of the primary side switches 308, 310 to the off state for a first off time duration toff1. The first off time duration toff1 may be greater than the first on time duration ton1.

In the second control state (labelled by “state 2”), the controller 300 is configured to switch the primary side switch 310 to the on state for a second on time duration ton2 and then switch each of the primary side switches 308, 310 to the off state for a second off time duration toff2.

In the present example, the controller 300 operates in the first control state followed by the second control state, and cycles between both states repeatedly to provide the necessary control operation for the power converter 302. It will be appreciated that in further embodiments, the controller 300 may operate in one or more further control states in addition to the two control states illustrated in the present example.

The power converter 302 may, for example, be a half bridge converter or a full bridge converter. The power converter 302 may be a forward-type half-bridge converter. The power converter 302 may be a resonant half bridge converter.

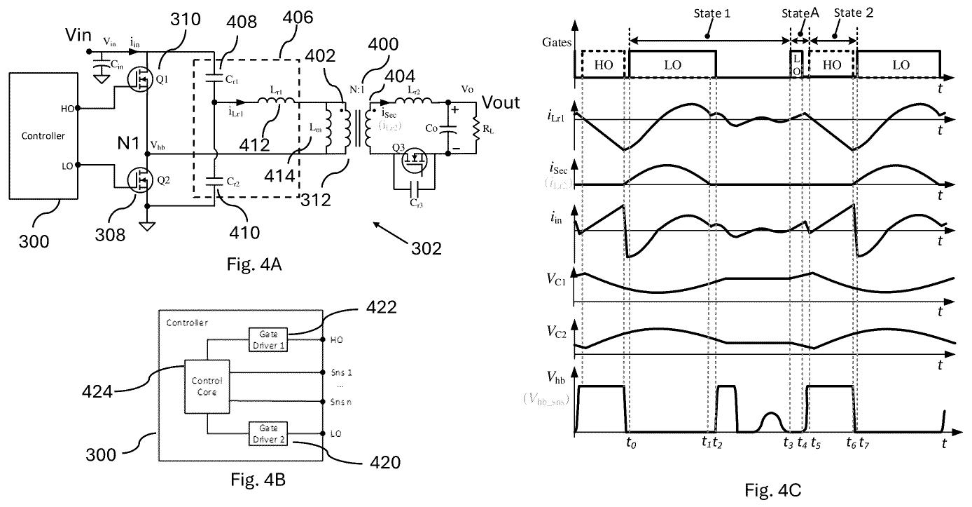

FIG. 4A is a schematic of a specific embodiment of the controller 300 and power converter 302 in accordance with a second embodiment of the present disclosure.

In the present embodiment, the power converter 302 is a resonant half bridge converter. The primary side switches 308, 310 are coupled at a node N1 which is coupled to the energy transfer element 312. In the present embodiment, the energy transfer element 312 comprises a transformer 400 comprising a primary winding 402 coupled to the node N1, and a secondary winding 404.

The primary side switch 310 is a high side switch (also labelled Q1) and the primary side switch 308 is a low side switch (also labelled Q2). In the schematic, both primary side switches 308, 310 are implemented as MOSFETs. However, as discussed previously, alternative transistor types may be used in further embodiments.

For clarity in the schematic, the labelling of the primary side and the secondary side have been omitted. It will be clear to the skilled person that the primary and secondary sides are separated by the windings 402, 404 of the transformer 400.

The power converter 302 comprises a resonant tank 406. The resonant tank 406 may comprise one or more resonant tank capacitors. In the present example, the resonant tank 406 comprises resonant tank capacitors 408, 410 and a leakage inductance 412 of the transformer 400. In further embodiments, the resonant tank 406 may comprise additional external inductances in series with the leakage inductance 412. An inductor 414 represents the inductance of the transformer 400.

The resonant tank 406 (which may be referred to as a “resonance network”) plays a role in shaping the performance of the power converter 302 by defining multiple resonant periods that influence switching characteristics.

In the present example, the primary side switches 308, 310 are coupled in series between a first voltage terminal for receiving the input voltage Vin and a second voltage terminal for receiving a reference voltage, such as ground.

The series coupling of the primary side switch 310, being the high side switch, and the primary 30 side switch 308, being the low side switch forms a half-bridge structure between a direct current (DC) input voltage (Vin) and a reference voltage, such as ground. In scenarios where the input power source is an alternating current (AC) voltage—such as mains power used in power supply applications-a rectifier circuit, such as a diode bridge rectifier, may be incorporated to convert the AC voltage into the required DC input voltage Vin.

The power converter 302 may further comprise a capacitor Cᵢₙ, an inductor Lᵣ₂, an output capacitor Co, a capacitor Cᵣ₃, a switch Q3 and a resistor R_{L}.

The switch Q3 may be a secondary-side actively controlled switch, which may be substituted for a diode in a further embodiment.

The primary winding 402 of the transformer 400 is coupled to both ground and the input voltage Vin through dual resonant capacitors 408, 410 (also labelled Cᵣ₁ and Cᵣ₂). The capacitances of the resonant capacitors 408, 410 may be equal or differ depending on the specific design requirements. The node N1 is a midpoint node between the primary side switches 308, 310 and serves as the connection point to the opposite end of the primary winding 402.

The transformer 400 includes the secondary winding 404, with the winding polarity indicated by dots, following standard industry conventions. In this particular embodiment, the primary and secondary windings 402, 404 are wound in the same direction. The secondary winding 404 delivers power to the output through the inductor Lᵣ₂, which can either be an external inductor or an integrated component of the transformer 400 or a combination of both.

The switch Q3 couples the second end of the secondary winding 404 to ground. The capacitor Cᵣ₃ (which may be an external capacitor) or the parasitic capacitance of the switch Q3, or a combination of both, is connected in parallel with the switch Q3.

Additionally, the output capacitor Co is placed between the output terminal at the output voltage Vout and ground, thereby functioning as a filter in conjunction with the inductance Lᵣ₂ to stabilize the output voltage Vout.

In further embodiments of the present disclosure, additional conventional elements typically found in forward-type Half-Bridge Converters—particularly forward-type Resonant Half-Bridge Converter circuits—may be integrated. These can include protective mechanisms such as overcurrent protection, voltage clamping diodes for resonant capacitors, as well as feedback control functionalities.

The controller 300 may be configured to operate in an auxiliary control state. Whilst operating in the auxiliary control state the controller 300 is configured to switch the primary side switch 308 to the on state for an auxiliary on time duration and switch each of the first and second primary side switches 308, 310 to the off state for an auxiliary off time duration, after the auxiliary on time duration. The auxiliary control state may be a further energy transfer state.

The primary winding 402 of the transformer 400 may exchange energy with an input source (for example the input voltage Vin) while simultaneously transferring energy to the secondary winding 404, whilst the controller 300 is operating in one of the first, second and auxiliary control states,

Due to the presence of parasitic capacitances in transistor switches such as the primary side switches 308, 310, unwanted energy losses can occur when a switch transitions from OFF to ON while a voltage is present across its terminals. To mitigate these losses, some embodiments may implement zero voltage switching (ZVS), wherein switching occurs when the applied voltage is near or at zero. To facilitate ZVS, the controller 300 may be configured to ensure that one switch remains ON for a specific duration within the three control states, thereby influencing the voltage conditions before the next switching event.

FIG. 4B is a schematic of a specific embodiment of the controller 300 as may be implemented in any of the embodiments described herein, in accordance with the understanding of the skilled person.

The controller 300 comprises a gate driver 420 for providing a first gate drive signal LO to drive the switching operation of the primary side switch 308 and a gate driver 422 for providing a second gate drive signal HO to drive the switching operation of the primary side switch 310.

The controller 300 may further comprise a control core 424 configured to provide a first control signal to the gate driver 420, where the first gate drive signal being provided by the gate driver 420 is dependent on the received first control signal. The control core 424 is further configured to provide a second control signal to the gate driver 422, the second gate drive signal being dependent on the second control signal.

The control core 424 may comprise one or more of one or more logic circuits, an application specific integrated circuit (ASIC), a processor, and/or other control-related components.

When the control core 424 comprises one or more processors, they can be programmed via a dedicated computer program stored on a tangible storage medium. The control core 424 may receive multiple sensing signals (Sns_1, . . . , Sns_n) through input terminals (which may be referred to as “Sns input pins”). These input signals may include:
A signal derived from Vhb (the voltage at the node N1 and denoted “Vhb” in FIG. 4A).
Information related to the input voltage Vin.
Data regarding the required or actual output voltage (e.g., Vout in FIG. 4A).
Any additional sensing signals conventionally used in forward-type converters or other voltage converters.

Based on these sensing inputs, the control core 424 may drive the gate driver 422 to generate the gate drive signal HO for the high-side switch (the primary side switch 310, also labelled Q1 in FIG. 4A) and the gate driver 420 may output the gate drive signal LO for the low-side switch (the primary side switch 308, also labelled Q2 in FIG. 4A). This control strategy may ensure that the forward-type resonant half-bridge converter 302 operates effectively to maintain the desired output voltage Vout.

FIG. 4C is a timing graph showing waveforms relating to a practical implementation of the controller 300 and the power converter 302 of FIG. 4A.

FIG. 4C provides a set of waveform diagrams that illustrate the corresponding signal behaviors for the present embodiment. It will be appreciated that these graphs serve as a conceptual representation, with actual waveforms subject to variation depending on specific implementation details.

The waveforms in FIG. 4C include:
Gate drive signals HO, LO:
   The topmost graph displays the gate drive signals HO (for the primary side switch 310, also labelled Q1) and LO (for the primary side switch 308, also labelled Q2).
   The solid-line pulses represent the LO signal controlling Q2, while the dashed-line pulses represent the HO signal controlling Q1.
   A high state indicates that the corresponding switch is turned on, while a low state signifies that the switch is turned off.
Transformer current (i_{Lr1}, i_{Sec}) and input current (iᵢₙ):
   The graph labelled i_{Lr1} shows the primary-side current I_{Lr1} flowing through the primary winding 402 of the transformer 400 and the graph labelled i_{Sec} shows secondary-side current i_{Sec} delivered to the output.
   Input current iᵢₙ represents the input current flow from Vin.
Resonant Capacitor Voltages (V_{C1}, V_{C2}):
   The voltage waveforms V_{C1} is the voltage across the resonant capacitor 408 and the voltage waveform V_{C2} is the voltage across the resonant capacitor 410.
1. Half-bridge midpoint voltage Vhb and its sensing signal (Vhb_sns):
   The V_{hb} waveform corresponds to the voltage at the midpoint node N1 between the primary side switches Q1 and Q2.
   The V_{hb_sns} sensing signal closely follows V_{hb}, except that its amplitude is lower due to step-down scaling.
   V_{hb_sns} is routed to one of the Sns input pins of the controller 300 (FIG. 4B), where it plays a role in timing control for switching the primary-side switches 308, 310.
   V_{hb_sns} may be derived from V_{hb} using either an isolated method (e.g., an auxiliary winding on the forward-type converter transformer core) or a non-isolated method (e.g., resistive voltage dividers, or converting V_{hb} into a current signal flowing into one of the Sns input pins via a current limit resistor.)

During operation the controller 300 may apply a first control sequence by repeatedly cycling between:
1. operating in the first control state (State 1);
2. operating in the auxiliary control state (State A); and
3. operating in the second control state (State 2).

Whilst applying the first control sequence, the controller 300 may operate in the first control state, before transitioning to the auxiliary control state, then the second control state before cycling back to the first control state and repeating the sequence.

When applying the first control sequence transitioning from the first control state to the auxiliary control state may occur after the first off time duration has elapsed; transitioning from the auxiliary control state to the second control state may occur after the auxiliary off time duration has elapsed; and transitioning from the second control state to the first control state may occur after the second off time duration has elapsed.

In specific embodiments, the power switches (the primary side switches 308, 310) may operate in a Discontinuous Conduction Mode (DCM).

The first control sequence comprises three distinct states, which transition sequentially in a repeating cycle. The initial state of the cycle may be any of the three states (State 1, State A, State 2). Each state comprises two actions: (1) one of the primary side switches 308, 310 is turned on for a specific duration, which may be determined by the control logic provided by the control core 424 and the current state; and (2) both primary-side switches 308, 310 are subsequently turned off for a defined period.

In DCM, the timing for switching actions in these three states may be influenced by sensed signals received by the controller 300 (as denoted by Sns 1, . . . , Sns n) which may be sensed from the power converter 302.

The present embodiment is described in relation to DCM. However, further embodiments may use alternative modes of operation. For example, DCM may be particularly suited for scenarios where the power converter 302 supplies a relatively low output power or when a lower output voltage is required.

A detailed description of the three-state switching method provided by the controller 300 of the present embodiment may be summarised as follows:

### State 1: Energy Transfer

In State 1, the operation comprises two key actions:
1. Turn on the primary side switch 308 (also labelled Q2) for a defined on-duration (may be referred to as the “first on time duration”).
2. Turn off both primary side switches 308, 310 (also labelled Q1 and Q2) for a defined off-duration (may be referred to as the “first off time duration”).

As shown in FIG. 4A, the primary side switch 308 is a low-side switch, and the second primary side switch 310 is a high-side switch. Turning on the primary side switch 308 initiates energy transfer from the input to the secondary side of the transformer 400 directly. At a time to in FIG. 4C, the midpoint voltage Vhb is near zero, allowing for zero-voltage switching (ZVS) or reduced-voltage switching for the primary side switch 308, thereby minimizing switching losses. The corresponding LO pulse in State 1 represents the turning on of the primary side switch 308.

During this State1, energy from the input may be directly transferred to the load through the resonant capacitor 408, which connects the primary winding 402 to the input via the primary side switch 308. As shown in FIG. 4C, the input current iᵢₙ and the secondary-side current i_{Sec} remain synchronized in State1, indicating simultaneous energy exchange from input to output. This is a characteristic feature of forward-type resonant converters. Additionally, during State1 of this forward-type resonant half-bridge converter, the transformer 400 enters a resonant mode, and the current i_{Lr1} exhibits a sinusoidal-like waveform from the time to t₀ a time t₁. This resonance involves multiple resonant components within the resonant tank 406.

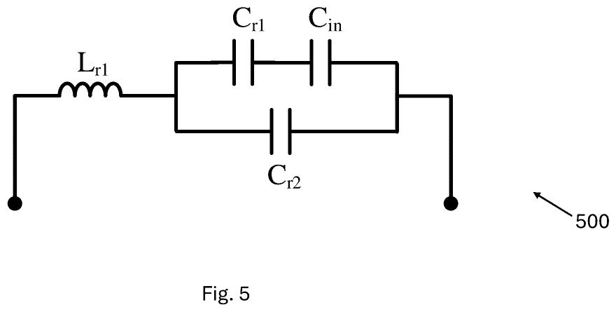

FIG. 5 is a schematic of an equivalent circuit 500 of the forward type resonant half-bridge converter 302 of FIG. 4A during resonance. From the perspective of the transformer inductance Lₘ, the equivalent circuit representing the components at resonant is as shown in FIG. 5.

Accordingly, based on the equivalent circuit above, the resonance period can be expressed as:

$$\\ \begin{matrix}{T}_{r} = 2 π \sqrt{{L}_{r 1} ( \frac{{C}_{r 1} {C}_{in}}{{C}_{r 1} + {C}_{in}} + {C}_{r 2} )} . & ( 1 )\end{matrix}$$

From a time t₂ to a time t₃, the first off time duration begins, temporarily pausing energy transfer to the transformer's secondary side 404. This prevents excessive energy delivery, enabling stable operation over a wide power and output voltage range. This energy transfer pause during the first off duration is particularly beneficial at low output power conditions. Therefore, the first off duration may be significantly longer than the first on duration during light load. State 1 ends when V_{hb_sns} reaches or is near its local minimum, thereby signaling an optimal switching point for turning on the primary side switch 308 again in the subsequent State A.

### State A: Auxiliary for Reset Transformer Winding

In State A, the following actions take place:
1. Turn on the primary side switch 308 (also labelled Q2) for an auxiliary on-duration (may be referred to as the “auxiliary on time duration”).
2. Turn off both primary side switches 308, 310 (also labelled Q1 and Q2) for an auxiliary off-duration (may be referred to as the “auxiliary off time duration”).

State A serves as an auxiliary phase to facilitate transformer 400 winding reset in State 2, thereby ensuring that the reset switch (being the primary side switch 310) achieves zero-voltage switching (ZVS). Resetting the winding is a requirement for forward-type converters.

With reference to FIG. 4A turning the primary side switch 308 on again facilitates energy transfer from the input source to the resonant tank 406, ensuring that the transformer 400 winding reset during State 2 is achieved with zero-voltage switching (ZVS).

In FIG. 4C, the corresponding LO pulse controls the primary side switch 308, pulling a tank current i_{Lr1}, where the energy for this current originates directly from the input voltage Vin (as shown by iᵢₙ in FIG. 4A). This operation generates voltage oscillation on Vhb, assisting in ZVS for the primary side switch 310 in the subsequent State2.

After the auxiliary on-duration (from a time t₃ to a time t₄), the auxiliary off-duration follows (from the t₄ to a time t₅). During this period, the input current from Vin raises Vhb to approximate Vin. Once Vhb reaches Vin approximately, the voltage across the primary side switch 310 is minimized, thereby reducing energy loss whilst the primary side switch 310 is on in State 2. State A ends at the time t₅, transitioning the converter 302 to State 3.

### State 2: Transformer Reset and Voltage Balancing

In State 2, the following actions take place:
1. Turn on the primary side switch 310 (also labelled Q1) for a second on-duration (may be referred to as the “second on time duration”).
2. Turn off both primary side switches 308, 310 (also labelled Q1 and Q2) for a second off-duration (may be referred to as the “second off time duration”).

At the time t₅, State 2 begins with the primary side switch 310 (the high-side switch) turning on for the second on-duration. This step ensures proper transformer 400 winding reset, thereby preventing saturation while maintaining voltage balance between the dual resonant capacitors 408, 410, as seen in FIG. 4A.

During the second off-duration (a time t₆ to a time t₇), Vhb decreases, and the associated energy is recycled back to the input Vin. As Vhb approaches ground, the voltage across the primary side switch 308 is minimized, thereby facilitating low-loss switching in the State 1 of next cycle. At a time t₇, State 2 ends, and the control method transitions back to State 1, thereby initiating a new cycle.

It will be appreciated that although the cycle description starts with State 1, the starting state of cycle may vary to be any of State 1, State A or State 2 based on system conditions. The control core 424 may determine the starting state of the control operating cycle using sensing signals (Sns_1 . . . Sns_n) or set a default starting state accordingly. The cycle may be ended at any of the three states—State 1, State A, or State 2.

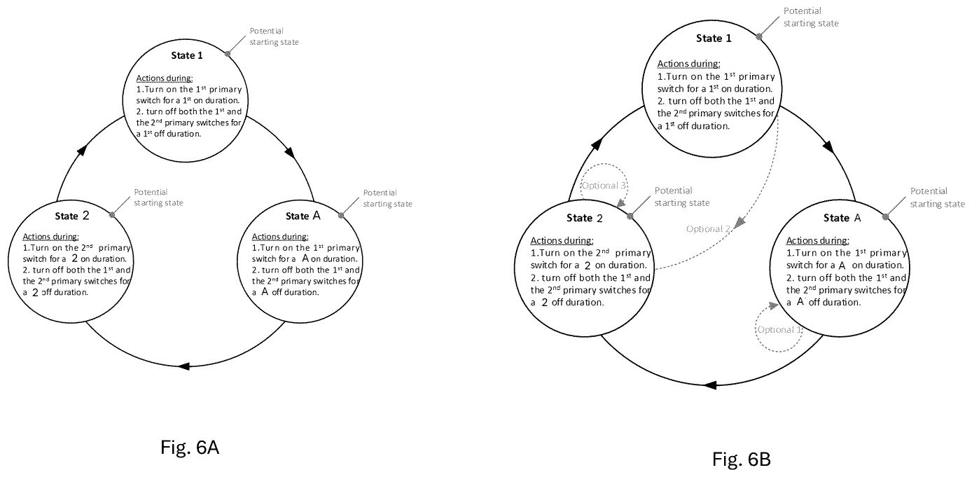

FIG. 6A is a flowchart outlining the three-state control method that transitions sequentially in a repeating cycle, where each state comprises two key actions:
1. One of the primary switches (Q1 or Q2) is turned on for a defined duration, which may be determined by the control core 424.
2. Both primary-side switches (Q1 and Q2) are turned off for a specific period before transitioning to the next state.

In further embodiments, the controller 300 may be configured to apply different control sequences which may, for example, be dependent on different operating conditions of the controller.

In summary, for a specific embodiment, the control core 424 may control the switch driver 420 and the switch driver 422 of the controller 300. The control logic of the control core 424 for these two drivers 420, 422 is as follows: there are three states for the control logic. The three states transition sequentially into a repeating cycle: State 1 transitions to State A, State A transitions to State 2, and State 2 transitions back to State 1. The default starting state of the cycle can be set to any of the three states—State 1, State A, or State 2. The cycle may be ended at any of the three states—State 1, State A, or State 2.

FIG. 6B is a flowchart outlining the three state control method as provided by the controller 300 for different control sequences. A first control sequence is as described previously in relation to FIG. 6A.

The controller 300 may be configured to apply a second control sequence by repeatedly cycling between operating in the first control state (State 1) and operating in the second control state (State 2). This sequence omits the auxiliary state (State A) and is labelled “Optional 2” in FIG. 6B.

In summary, the controller 300 may optionally bypass State A, transitioning directly from State 1 to State 2 before transitioning back to State 1.

Optional 2 may be used for a High-Power Operation mode of the power converter 302 (continuous conduction mode (CCM) Mode or critical conduction mode (CRM) Mode). When the converter 302 is required to deliver higher output power, the controller 300 may bypass State A, transitioning directly from State 1 to State 2 before looping back to state 1. This configuration enables operation in CCM or CRM, which occurs at the boundary between CCM and DCM.

The control core 424 may dynamically determine when to enable this optional feature based on inputs Sns_1 . . . Sns_n, as shown in FIG. 4B. In further embodiments, the control mode setting may adhere to preconfigured enabling logic.

In summary, the controller 300 may apply the first control sequence when the power converter 302 is operating in the DCM mode and/or may apply the second control sequence when the power converter 302 is operating in the CCM mode or the CRM mode.

The controller 300 may be configured to apply a third control sequence by repeatedly cycling between operating in the first control state (State 1), operating in the auxiliary control state (State A) and repeatedly operating in the second control state (State 2) for two or more switching cycles before returning to State 1. This sequence is labelled “Optional 3” in FIG. 6B.

In summary, this involves executing State 2 multiple times (>1 time) before transitioning to State 1. This approach ensures proper transformer reset or serves other functional purposes (such as balancing the dual resonant capacitor voltages (V_{C1} and V_{C2})). The control core 424 may monitor one or more sensed signals (Sns_1 . . . Sns_n, as shown in FIG. 4B) to detect incomplete winding reset or unbalanced dual resonant capacitor voltage, and determine whether to enable this feature. It can dynamically decide the number of times State 2 should be repeated or simply follow a preset execution count.

The controller 300 may be configured to apply a fourth control sequence by repeatedly cycling between operating in the first control state (State 1), repeatedly operating in the auxiliary control state (State A) for two or more switching cycles before transitioning to the second control state (State 2), and then operating in the second control state (State 2) before returning to State 1. This sequence is labelled “Optional 1” in FIG. 6B.

In summary, this involves executing State A multiple times (>1 time) before transitioning to State 2. This approach is particularly beneficial during startup or under low-load conditions, where the switch turn-on durations are short. Repeating State A ensures adequate charging of the bootstrap capacitor Cᵢₙ to the required voltage level necessary for driving the high-side switch (the primary side switch 310). The control core 424 may dynamically decide the number of times State A should be repeated based on Sns_1 . . . Sns_n, as shown in FIG. 4B, or may simply follow a preset execution count.

The control core 424 may be configured to sense one or more parameters of the power converter 302 (as illustrated by sensing signals Sns_1, . . . , Sns_n) and to adjust the one or both of the control signals as provided to the gate drivers 420, 422 based on the sensed one or more parameters.

The one or more parameters may comprise: the input voltage Vin, the output voltage Vout, a node voltage VHB at the node N1, a transformer primary side current, and a resonant tank capacitor voltage.

In a specific embodiment, the initial state of the repeated sequence may be selected based on the one or more sensed parameters.

The controller 300 may be configured to, when applying the first control sequence transition from operating in the auxiliary control state to operating in the second control state when the node voltage VHB at the node N1 exceeds a maximum threshold value, and/or transition from operating in the second control state to operating in the first control state when the node voltage VHB at the node N1 falls below a minimum threshold value.

In summary, in a specific embodiment, the control logic of the control core 424 may initiate State1 follows by State A when the voltage at the node N1 is at or near its local minimum value.

In summary, in a specific embodiment, the control logic of the control core 424 may initiate State 2 when the voltage at the node N1 is at or near its local maximum value.

The controller 300 may be configured to set one or more of the on or off time durations of each of the states based on the one or more sensed parameters.

The auxiliary on time duration may be set based on one or more of the output voltage Vout, the transformer primary side current and the resonant tank capacitor voltage.

In summary, in a specific embodiment, the control logic of the control core 424 may adjust the first on time duration based on an input signal indicative of the voltage at the node N1.

In summary, in a specific embodiment, the control logic of the control core 424 may adjust the first off time duration based on an input signal indicative of output conditions (for example the output voltage Vout) and an input signal indicative of the voltage at the node N1.

In a specific embodiment, the first off time duration may be significantly longer than the first on time duration.

In summary, in a specific embodiment, the control logic of the control core 424 may adjust the auxiliary on time duration based on an input signal indicative of the input voltage Vin and an input signal indicative of the voltage at the node N1.

In summary, in a specific embodiment, the control logic of the control core 424 may adjust the second on time duration based on an input signal indicative of transformer primary side current or resonant tank capacitor voltage, in conjunction with an input signal indicative of output conditions.

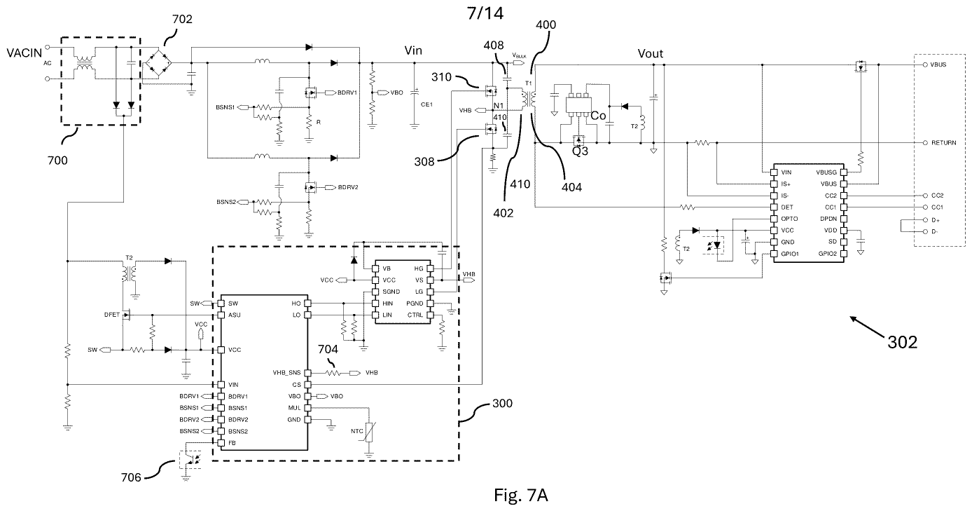

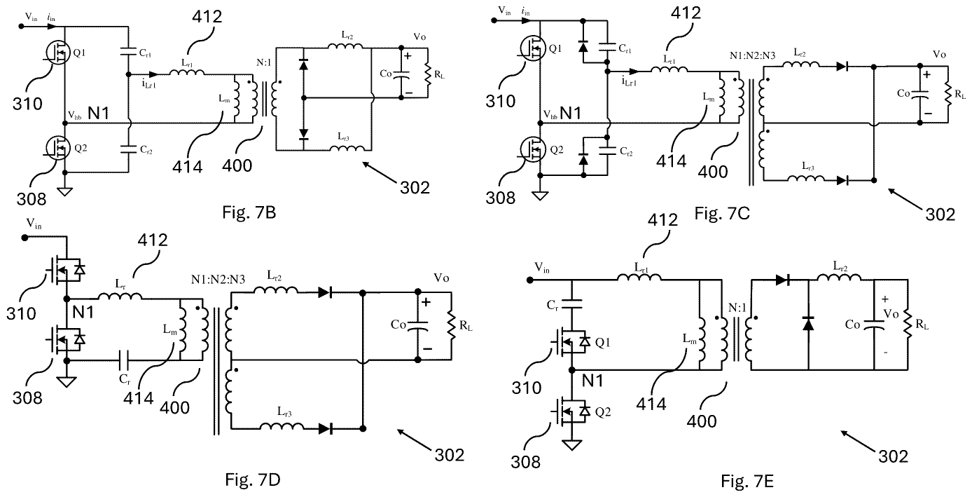

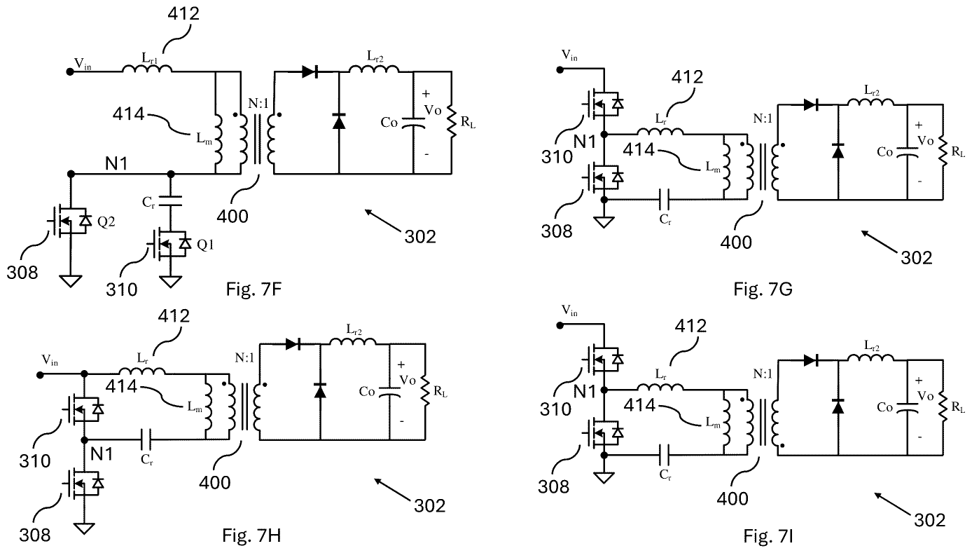

FIG. 7A is a schematic of a specific implementation of the controller 300 and the power converter 302 in accordance with a third embodiment of the present disclosure. The controller 300 may be configured to function substantially as described for any of the controller embodiments described herein to control the power converter 302, in accordance with the understanding of the skilled person.

In the present embodiment, the power converter 302 is a forward-type resonant half-bridge converter. During operation, the power converter 302 receives an AC input voltage, VACIN, which may vary between approximately 80 V and 264 V AC, accommodating mains voltages across different regions. This AC voltage is processed through a filtering stage 700 and a rectifier stage 702, converting it into a DC input voltage, Vin.

In further embodiments, a signal representing the magnitude of VACIN may be provided to the controller 300 via an input pin, while a voltage divider at a further input pin of the controller 300 may supply information about Vin.

In some embodiments, a power factor correction (PFC) circuit may also be included and implemented using conventional methods.

The controller 300 may govern the operation of the primary side switch 310 (high-side switch Q1) and the primary side switch 308 (low-side switch Q2) based on a three-state control method, as previously discussed.

In a specific embodiment, the controller 300 may regulate the primary side switches 308, 310 using the control method described in FIG. 6A and/or FIG. 6B, and may generate switching signals similar to those shown in FIG. 4C.

Through the controlled operation of the primary side switches 308, 310 energy is transferred to the primary winding 402 of the transformer 400. On the secondary side, the output voltage, Vout, is derived from the secondary winding 404 of the transformer 400 and may be rectified using a synchronous rectifier (SR) circuit, which may include a synchronous rectifier switch controlled by a synchronous rectifier controller. A filtering capacitor may smooth the rectified voltage.

A sensing signal, VHB_SNS, may be obtained by connecting the VHB pin to the VHB_SNS pin through a current-limiting resistor 704. This signal may be used to determine the timing and duration of switching pulses. Additionally, the output voltage Vout may be fed back to the controller 300 via an optocoupler 706, providing galvanic isolation. This feedback signal, received at the FB input of the controller 300, may be used to regulate pulse durations in the switching sequence, ensuring stable operation.

It will be appreciated that further embodiments of the present disclosure may exclude certain components described in relation to any of the embodiments described herein, or may substitute them with alternatives.

While the described method is applied to the forward-type resonant half-bridge converter with dual resonant capacitors, the principles extend to other variations of forward-type resonant half-bridge topology.

FIG. 7B is a schematic of a specific implementation of the power converter 302 as may be used with any of the controller 300 embodiments described herein, in accordance with the understanding of the skilled person, and in accordance with a fourth embodiment of the present disclosure.

FIG. 7C is a schematic of a specific implementation of the power converter 302 as may be used with any of the controller 300 embodiments described herein, in accordance with the understanding of the skilled person, and in accordance with a fifth embodiment of the present disclosure.

FIG. 7D is a schematic of a specific implementation of the power converter 302 as may be used with any of the controller 300 embodiments described herein, in accordance with the understanding of the skilled person, and in accordance with a sixth embodiment of the present disclosure.

FIG. 7E is a schematic of a specific implementation of the power converter 302 as may be used with any of the controller 300 embodiments described herein, in accordance with the understanding of the skilled person, and in accordance with a seventh embodiment of the present disclosure.

FIG. 7F is a schematic of a specific implementation of the power converter 302 as may be used with any of the controller 300 embodiments described herein, in accordance with the understanding of the skilled person, and in accordance with an eighth embodiment of the present disclosure.

FIG. 7G is a schematic of a specific implementation of the power converter 302 as may be used with any of the controller 300 embodiments described herein, in accordance with the understanding of the skilled person, and in accordance with a ninth embodiment of the present disclosure.

FIG. 7H is a schematic of a specific implementation of the power converter 302 as may be used with any of the controller 300 embodiments described herein, in accordance with the understanding of the skilled person, and in accordance with a tenth embodiment of the present disclosure.

FIG. 7I is a schematic of a specific implementation of the power converter 302 as may be used with any of the controller 300 embodiments described herein, in accordance with the understanding of the skilled person, and in accordance with an eleventh embodiment of the present disclosure.

FIG. 7A-7I illustrate examples of forward-type resonant half-bridge converters that convert the input voltage Vin to the output voltage Vout. Although the described controller operation provided by the controller 300 is primarily described in relation to half-bridge converters, the disclosed three-state control method can also be applied to full-bridge converters, where the two switches in one arm replicate the gate drive signals of the diagonal switch in the opposite arm. Moreover, the disclosed control method is adaptable, allowing features from different variations to be combined into a custom converter design while still benefiting from the proposed three-state switching control strategy.

It will be appreciated that the transformer secondary side diodes may be replaced by active controlled switches, such as FETs, BJTs or IGBTs, in further embodiments.

It will be appreciated that although the embodiments described herein primarily relate to forward-type resonant half-bridge converters comprising dual resonant capacitors, further embodiments may be applied to other types of power converters in accordance with the understanding of the skilled person.

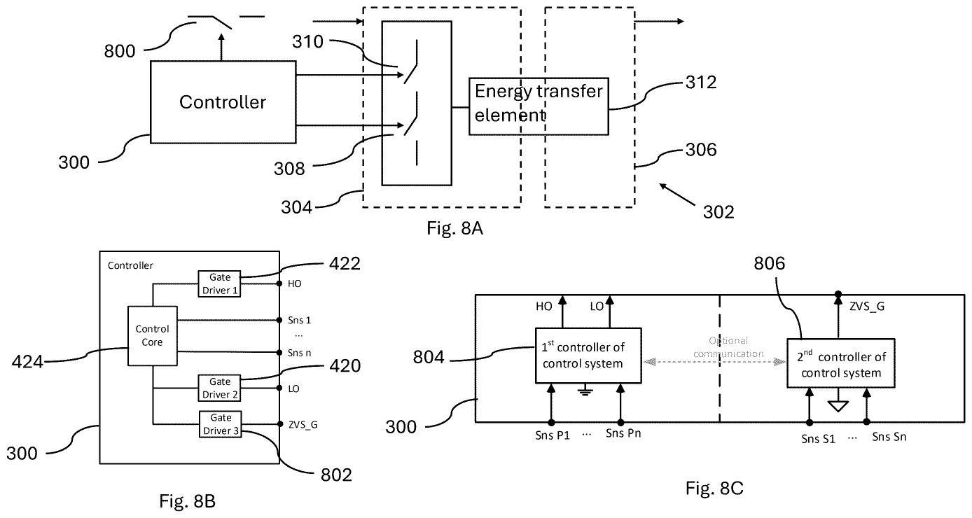

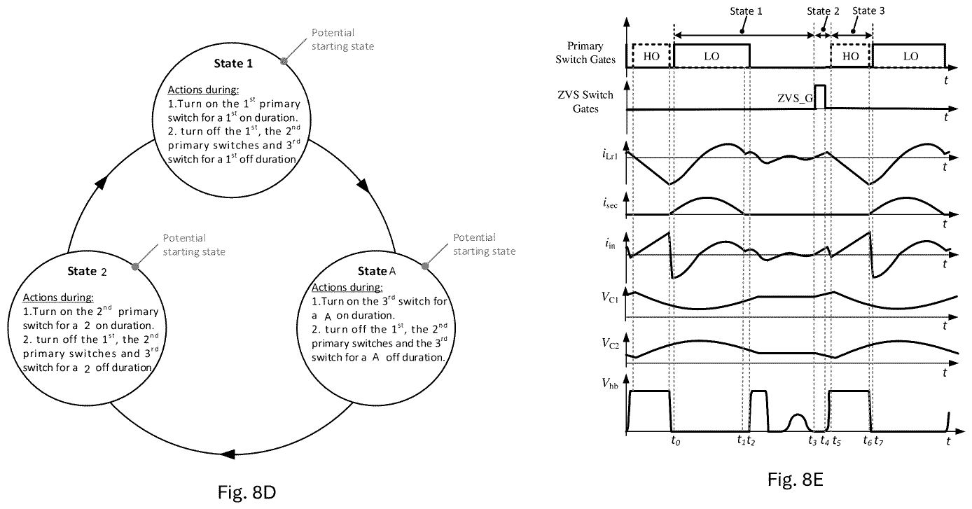

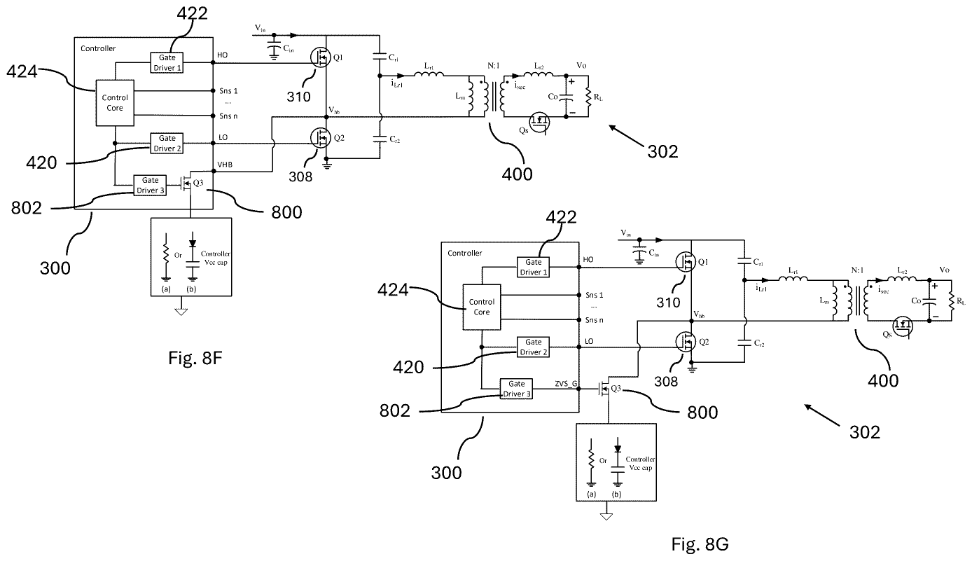

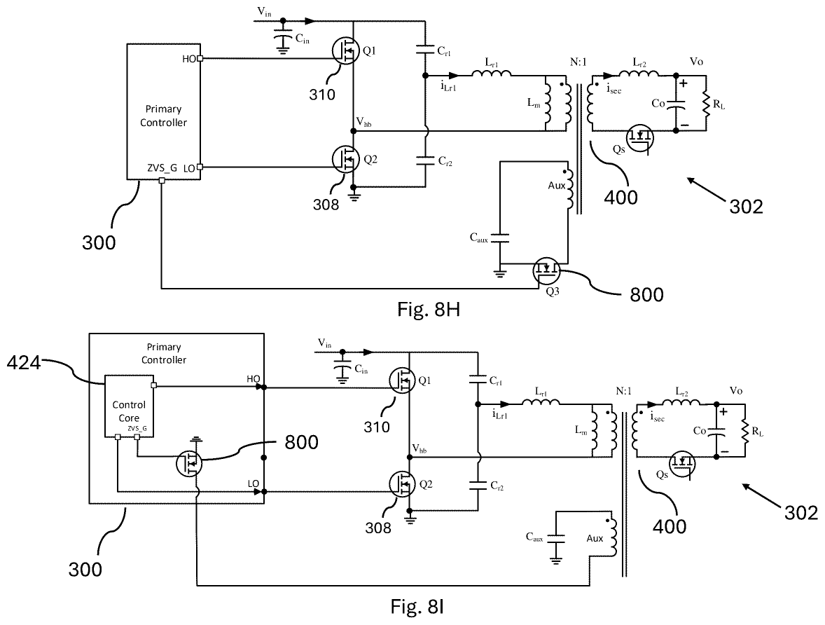

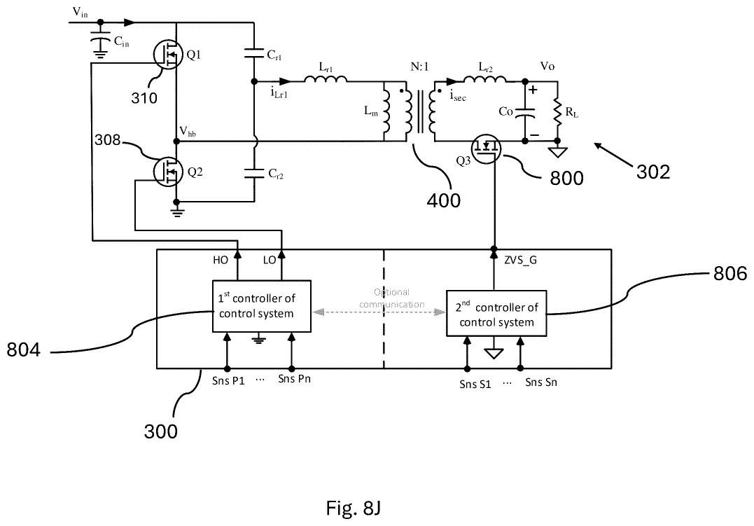

Further embodiments of the present disclosure may, for example, be applied to other forward-type half-bridge converters that comprise a transformer. Specifically, further embodiments may be applied to power converter configurations where two primary-side switches, coupled to the winding of the transformer, are controlled by distinct signals to alternately energize and demagnetize the transformer, thereby facilitating power transfer to the secondary side. FIG. 8A is a schematic of a specific implementation of the controller 300 and the power converter 302 in accordance with a twelfth embodiment of the present disclosure. As an alternative to the sequence outlined in FIG. 6A, the controller 300 may control an additional switch 800, rather than the primary side switch 308 during the auxiliary control state.

The controlling of the additional switch 800 in the auxiliary control state can provide the same, or substantially similar, result as described previously for the controlling of the primary side switch 308 during the auxiliary control state, in accordance with the understanding of the skilled person.

In the present embodiment, the controller 300, whilst operating in the auxiliary control state, is configured to switch the additional switch 800 to the on state for the auxiliary on time duration, and switch each of the primary side switch 308, the primary side switch 310 and the additional switch 800 to the off state for the auxiliary off time duration, after the auxiliary on time duration.

Additionally, whilst operating in the first control state, the controller 300 may be configured to switch each of the primary side switch 308, the primary side switch 310 and the additional switch 800 to the off state for the first off time duration, after the first on time duration, and whilst operating in the second control state, the controller 300 may be configured to switch each of the primary side switch 308, the primary side switch 310 and the additional switch 800 to the off state for the second off time duration, after the second on time duration.

FIG. 8B is a schematic of a specific implementation of the controller 300 in accordance with a thirteenth embodiment of the disclosure. The controller 300 of FIG. 8B may, for example, be used with a power converter system having the additional switch 800 for use in the auxiliary control state.

The controller 300 of the present example comprises an additional switch gate driver 802 for providing an additional gate drive signal ZVS_G to drive the switching operation of the additional switch 800. The control core 424 provides an additional control signal to the additional switch gate driver 802 with the additional gate drive signal ZVS_G being dependent on the received additional control signal.

FIG. 8C is a schematic of a further specific implementation of the controller 300 in accordance with a fourteenth embodiment of the disclosure. The controller 300 of FIG. 8C may, for example, be used with a power converter system having the additional switch 800 for use in the auxiliary control state.

The controller 300 of the present embodiment comprises a control module 804 comprising the first and second switch gate drivers (not shown) and a first control core (not shown) for the first and second switch gate drivers, and a control module 806 comprising the additional switch gate driver (not shown) and a second control core (not shown) for the additional switch gate driver.

FIG. 8D is a flowchart outlining the three-state control method that transitions sequentially in a repeating cycle, where each state comprises two key actions:
1. One of the switches 308, 310, 800 is turned on for a defined duration, which may be determined by the control core 424.
2. All switches 308, 310 800 are turned off for a specific period before transitioning to the next state

The additional switch 800 is referred to as the “3^{rd} switch” in the flow chart.

FIG. 8E is a timing graph showing waveforms relating to a practical implementation of the controller 300 and the power converter 302 of FIG. 8A. The waveform labels are as described for FIG. 4C. FIG. 8E shows example waveforms for disclosed three-state control logic, where State A is implemented by the switch 800 (ZVS switch), and it is driven by ZVS_G.

FIG. 8E provides a set of waveform diagrams that illustrate the corresponding signal behaviors for the present embodiment. It will be appreciated that these graphs serve as a conceptual representation, with actual waveforms subject to variation depending on specific implementation details.

State A, in addition to being executed by the primary-side switch 308, may also be executed by a third switch (i.e., the ZVS switch), as shown by the switch 800 in FIG. 4A.

In this case, the disclosed three-state control logic can be implemented by a controller system consisting of one or more control modules. For example, FIG. 4B illustrates the disclosed three-state control logic implemented by a single controller, which includes the control logic for a 3rd switch gate driver (Gate Driver 3) with an output labeled ZVS_G to drive the switch 800.

Similarly, FIG. 8C demonstrates the disclosed three-state control logic achieved using a controller system with two control modules 804, 806. In this configuration, the control logic for State A of the three-state control, as well as the additional gate driver 802, is implemented in the control module 806 of the controller.

The output of the gate driver 802, labelled ZVS_G, drives the additional switch 800. The control modules 804, 806 may share the same ground or operate with different grounds. Communication between control modules 804, 806 in the system is optional.

In further embodiments, rather than being integrated into a single controller or distributed across multiple controllers, the first switch driver 420, second switch driver 422, and third switch driver 802 can also be implemented as discrete circuits external to the controller 300, and may function as independent switch drivers.

In summary, for a specific embodiment, the control core 424 may control the switch driver 420, the switch driver 422 and the switch driver 802 of the controller 300. The control logic of the control core 424 for these three drivers 420, 422, 802 is as follows: there are three states for the control logic. The three states transition sequentially into a repeating cycle: State 1 transitions to State A, State A transitions to State 2, and State 2 transitions back to State 1. The default starting state of the cycle can be set to any of the three states—State 1, State A, or State 2. The cycle may be ended at any of the three states—State 1, State A, or State 2.

The additional switch 800 can be integrated into the controller 300 in the power controller system, or on the primary side of the transformer 400, or on the secondary side of the transformer 400, or on a third winding side of the transformer 400, or on an isolated ground side. If the additional switch 800 is on the secondary side of the transformer 400, it may also be turned on for synchronous rectification when current of secondary side is not zero in State 1 and/or State 2.

In further embodiments, the controller 300 may be configured to implement the optional control schemes as described in relation to FIG. 6B, using the additional switch 800 for the auxiliary control state.

In summary, the controller 300 may optionally execute State A multiple times before transitioning to State 2. In summary, the controller 300 may optionally bypass State A, transitioning directly from State 1 to State 2 before transitioning back to State 1. In summary, the controller 300 may optionally execute State 2 multiple times before transitioning to State 1.

In summary, the control logic of the control core 424 may initiate State 1 followed by State2 when the voltage at the node N1 is at or near its local minimum value.

In summary, the control logic of the control core 424 may initiates State 2 when the voltage at the node N1 is at or near its local maximum value.

In summary, the control logic of the control core 424 may adjust the first on time duration based on an input signal indicative of the voltage at the node N1.

In summary, the control logic of the control core 424 may adjust the first off time duration based on an input signal indicative of output conditions and an input signal indicative of the voltage at the node N1.

In a specific embodiment, the first off time duration may be significantly longer than the first on time duration.

In summary, the control logic of the control core 424, may adjust the auxiliary on time duration based on an input signal indicative of the input voltage Vin and an input signal indicative of the voltage at the node N1.

In summary, the control logic of the control core 424 may adjust the second on time duration based on an input signal indicative of transformer primary side current or resonant tank capacitor voltage, in conjunction with an input signal indicative of output conditions.

In a specific embodiment, in at least one control operating state, a primary winding of the transformer 400 is operative to exchange energy with the input source while simultaneously transferring energy to the secondary winding 404.

FIG. 8F is a schematic of a specific implementation of the power converter 302 as may be used with any of the controller 300 embodiments described herein, in accordance with the understanding of the skilled person, and in accordance with a fifteenth embodiment of the present disclosure.

In the present embodiment Q3, the additional switch 800, is incorporated within the primary-side controller 300. Zero-Voltage Switching (ZVS) in State 2 is realized by discharging resonant tank through Q3 in State A, using either a resistor or a resistor-capacitor circuit.

FIG. 8G is a schematic of a specific implementation of the power converter 302 as may be used with any of the controller 300 embodiments described herein, in accordance with the understanding of the skilled person, and in accordance with a sixteenth embodiment of the present disclosure.

In the present embodiment Q3, the additional switch 800, is located externally from the primary-side controller 300. Zero-Voltage Switching (ZVS) in State 2 is realized by discharging resonant tank through Q3 in State A, using either a resistor or a resistor-capacitor circuit.

FIGS. 8F and 8G illustrate how ZVS in State 2 is achieved by discharging the resonant tank through Q3 in State A, using either a resistor or a resistor-capacitor circuit.

FIG. 8H is a schematic of a specific implementation of the power converter 302 as may be used with any of the controller 300 embodiments described herein, in accordance with the understanding of the skilled person, and in accordance with a seventeenth embodiment of the present disclosure.

In the present example, the transformer 400 comprises an auxiliary winding Aux.

In FIG. 8H Q3, the additional switch 300, is placed outside of the primary-side controller 300. Zero-Voltage Switching (ZVS) in State 2 is realized by using Q3 to transfer Caux energy from Aux winding to Primary side winding of transformer 400 in State A. The source of energy stored in Caux can vary, originating from sources such as controller Vcc, input voltage (Vin), output voltage (Vo), or, as shown here, from the Aux winding itself in State 1.

FIG. 8I is a schematic of a specific implementation of the power converter 302 as may be used with any of the controller 300 embodiments described herein, in accordance with the understanding of the skilled person, and in accordance with an eighteenth embodiment of the present disclosure.

In FIG. 8I, Q3, the additional switch 800, is incorporated within the primary-side controller 300. Zero-Voltage Switching (ZVS) in State 2 is realized by using Q3 to transfer Caux energy from Aux winding to Primary side winding of transformer 400 in State A. The source of energy stored in Caux can vary, originating from sources such as controller Vcc, input voltage (Vin), output voltage (Vo), or, as shown here, from the Aux winding itself in State 1.

FIGS. 8H and 8I, are examples showing that Zero-Voltage Switching (ZVS) in State 2 is realized by using Q3 to transfer Caux energy from Aux winding to Primary side winding of transformer in State A. The source of energy stored in Caux can vary, originating from sources such as controller Vcc, input voltage (Vin), output voltage (Vo), or, as shown in FIG. 8G and FIG. 8H, from the Aux winding itself in State 1.

FIG. 8J is a schematic of a specific implementation of the power converter 302 as may be used with any of the controller 300 embodiments described herein, in accordance with the understanding of the skilled person, and in accordance with a nineteenth embodiment of the present disclosure.

FIG. 8J, the additional switch 800 is on the secondary side of transformer. Q3 gate driver is incorporated within the control module 806 of the controller 300. Zero-Voltage Switching (ZVS) in State 2 is realized by discharging Co through Q3 in State A to transfer Co energy from Secondary side winding to Primary side winding of transformer in State A.

FIG. 8J illustrates an alternative approach where ZVS in State 2 is achieved by discharging Co through Q3 in State A, transferring Co energy from the secondary winding to the primary winding of the transformer in State A. Other implementation circuits may exist, but the intended electrical behavior is to use the additional switch 800 in State A to assist the primary side switch 310 in State 2 to achieve zero-voltage switching (ZVS). For example, although the additional switch 800 is illustrated as N-type switches in these figures, the additional switch 800 can be implemented as either N-type or P-type switch, depending on the applications.

FIG. 8F-8J provide some examples of implementing the additional switch 800 in State A to facilitate ZVS in State 2.

Embodiments of the present disclosure may be combined to create further embodiments. Modifications described for one embodiment may be applied to others, in accordance with the understanding of the skilled person.

It will be appreciated that direct electrical connections (those without intermediate components) of embodiments disclosed herein may be replaced with indirect connections involving additional elements, provided that the fundamental functionality of transmitting signals, data, or control remains intact, in accordance with the understanding of the skilled person.

Embodiments of the present disclosure provide a controller using a novel operating sequence that enables forward-type resonant half-bridge converters to:
Maintain high efficiency across a universal input range (85-264 VAC).
Support a wide output voltage and power range for diverse applications.
Ensure optimal performance from no-load to full-load conditions.

Embodiments of the present disclosure address these challenges by introducing an improved operating sequence for two primary side switches (and optional 3^{rd} switch) that enhances ZVS operation, and adaptability across various operating conditions.

The present disclosure introduces a novel three-state control method for forward-type resonant half-bridge converters. This innovation enables zero-voltage switching (ZVS) for two primary side switches, resetting windings of transformer, enhancing efficiency across a wide input and output voltage range and the full load range.

The disclosed three-state control method to forward-type Resonant Half-Bridge Converter is designed for fast charging/powering consumer electronics, addressing the increasing power demands of modem devices. As smartphones, tablets, laptops, and wearable electronics integrate more powerful processors, larger displays, and multiple sensors (e.g., cameras, biometric sensors, etc.), the need for higher power delivery has become critical.

Various improvements and modifications may be made to the above without departing from the scope of the disclosure.

1. A controller for a power converter for receiving an input voltage at a primary side and generating an output voltage at a secondary side, the power converter comprising:
a first primary side switch configured to be switchable between an on state and an off state;
a second primary side switch configured to be switchable between the on state and the off state; and
an energy transfer element configured to transfer energy from the input voltage to the secondary side; wherein:
the controller is configured to:
operate in a first control state, wherein the controller, whilst operating in the first control state, is configured to:
i) switch the first primary side switch to the on state for a first on time duration; and
ii) switch each of the first and second primary side switches to the off state for a first off time duration, after the first on time duration; and
operate in a second control state, wherein the controller, whilst operating in the second control state, is configured to:
i) switch the second primary side switch to the on state for a second on time duration; and
ii) switch each of the first and second primary side switches to the off state for a second off time duration, after the second on time duration.

2. The controller of claim 1 configured to:
operate in an auxiliary control state, wherein the controller, whilst operating in the auxiliary control state, is configured to:
i) switch the first primary side switch to the on state for an auxiliary on time duration; and
ii) switch each of the first and second primary side switches to the off state for an auxiliary off time duration, after the auxiliary on time duration; or
i) switch an additional switch to the on state for the auxiliary on time duration; and
ii) switch each of the first primary side switch, the second primary side switch and the additional switch to the off state for the auxiliary off time duration, after the auxiliary on time duration.

3. The controller of claim 2, wherein:
whilst operating in the first control state, the controller is configured to:
switch each of the first primary side switch, the second primary side switch and the additional switch to the off state for the first off time duration, after the first on time duration; and
whilst operating in the second control state, the controller is configured to:
switch each of the first primary side switch, the second primary side switch and the additional switch to the off state for the second off time duration, after the second on time duration.

4. The controller of claim 2 configured to:
apply a first control sequence by repeatedly cycling between:
i) operating in the first control state;
ii) operating in the auxiliary control state; and
iii) operating in the second control state.

5. The controller of claim 4 configured to, when applying the first control sequence:
i) transition from operating in the first control state to operating in the auxiliary control state;
ii) transition from operating in the auxiliary control state to operating in the second control state; and
iii) transition from operating in the second control state to operating in the first control state.

6. The controller of claim 5 configured to, when applying the first control sequence:
i) transition from operating in the first control state to operating in the auxiliary control state after the first off time duration has elapsed;
ii) transition from operating in the auxiliary control state to operating in the second control state after the auxiliary off time duration has elapsed; and
iii) transition from operating in the second control state to operating in the first control state after the second off time duration has elapsed.

7. The controller of claim 4 configured to:
apply a second control sequence by repeatedly cycling between:
i) operating in the first control state; and
ii) operating in the second control state; and/or
apply a third control sequence by repeatedly cycling between:
i) operating in the first control state;
ii) operating in the auxiliary control state; and
iii) repeatedly operating in the second control state for a plurality of second control state switching cycles; and/or
apply a fourth control sequence by repeatedly cycling between:
i) operating in the first control state;
ii) repeatedly operating in the auxiliary control state for a plurality of auxiliary control state switching cycles; and
iii) operating in the second control state; wherein:
the controller is configured to switch between applying the first control sequence and one or more of the second, third and fourth control sequences.

8. The controller of claim 7 configured to:
when applying the second control sequence:
i) transition from operating in the first control state to operating in the second control state; and
ii) transition from operating in the second control state to operating in the first control state; and/or
when applying the third control sequence:
i) transition from operating in the first control state to operating in the auxiliary control state;
ii) transition from operating in the auxiliary control state to operating in the second control state; and
iii) transition from repeatedly operating in the second control state to operating in the first control state; and/or
when applying the fourth control sequence:
i) transition from operating in the first control state to operating in the auxiliary control state;
ii) transition from repeatedly operating in the auxiliary control state to operating in the second control state; and
iii) transition from operating in the second control state to operating in the first control state.

9. The controller of claim 8 configured to:
when applying the second control sequence:
i) transition from operating in the first control state to operating in the second control state after the first off time duration has elapsed; and
ii) transition from operating in the second control state to operating in the first control state after the second off time duration has elapsed; and/or
when applying the third control sequence:
i) transition from operating in the first control state to operating in the auxiliary control state after the first off time duration has elapsed;
ii) transition from operating in the auxiliary control state to operating in the second control state after the auxiliary off time duration has lapsed; and
iii) transition from repeatedly operating in the second control state to operating in the first control state after the second off time duration of the last of the plurality of second control state switching cycles has elapsed; and/or
when applying the fourth control sequence:
i) transition from operating in the first control state to operating in the auxiliary control state after the first off time duration has elapsed;
ii) transition from repeatedly operating in the auxiliary control state to operating in the second control state after the auxiliary off time duration of the last of the plurality of auxiliary control state switching cycles has elapsed; and
iii) transition from operating in the second control state to operating in the first control state after the second off time duration has elapsed.

10. The controller of claim 4 configured to:
apply the first control sequence when the power converter is operating in a discontinuous conduction mode (DCM); and/or
apply the second control sequency when the power converter is operating in a continuous conduction mode (CCM) or a critical conduction mode (CRM).

11. The controller of claim 1 wherein:
the first primary side switch and the second primary side switch are coupled at a first node; and
the energy transfer element is coupled to the first node.

12. The controller of claim 11 comprising a first switch gate driver for providing a first gate drive signal to drive the switching operation of the first primary side switch and a second switch gate driver for providing a second gate drive signal to drive the switching operation of the second primary side switch.

13. The controller of claim 12 comprising a control core configured to:
provide a first control signal to the first switch gate driver, the first gate drive signal being dependent on the first control signal; and
provide a second control signal to the second switch gate driver, the second gate drive signal being dependent on the second control signal.

14. The controller of claim 13 wherein the control core is configured to sense one or parameters of the power converter and to adjust the first and/or second control signals based on the sensed one or more parameters.

15. The controller of claim 14, wherein the one or more parameters comprises:
the input voltage;
the output voltage; and
a node voltage at the first node.

16. The controller of claim 14 configured to:
operate in an auxiliary control state, wherein the controller, whilst operating in the auxiliary control state, is configured to:
i) switch the first primary side switch to the on state for an auxiliary on time duration; and
ii) switch each of the first and second primary side switches to the off state for an auxiliary off time duration, after the auxiliary on time duration;
apply a first control sequence by repeatedly cycling between:
i) operating in the first control state;
ii) operating in the auxiliary control state; and
iii) operating in the second control state.

17. The controller of claim 16 configured to:
apply the first control sequence by operating in an initial state prior to repeatedly cycling between operating in the first, auxiliary and second control states; wherein:
the initial state is one of the first, auxiliary and second control states and is dependent on one or more of the parameters as sensed by the control core.

18. The controller of claim 16, wherein:
one of the one or more parameters is a node voltage at the first node; and
the controller is configured to, when applying the first control sequence:
i) transition from operating in the auxiliary control state to operating in the second control state when the node voltage exceeds a maximum threshold value; and/or
ii) transition from operating in the second control state to operating in the first control state when the node voltage falls below a minimum threshold value.

19. The controller of claim 16 configured to set, based on the one or more parameters sensed by the control core, one or more of:
the first on time duration;
the first off time duration;
the second on time duration;
the second off time duration;
the auxiliary on time duration; and
the auxiliary off time duration.

20. The controller of claim 11, wherein:
the energy transfer element comprises a transformer comprising a primary winding and a secondary winding, the primary winding being coupled to the first node; and
the power converter comprises a resonant tank comprising one or more resonant tank capacitors.

21. The controller of claim 1, wherein the power converter is a forward-type resonant half-bridge converter.

22. A power converter system comprising:
a power converter for receiving an input voltage at a primary side and generating an output voltage at a secondary side, the power converter comprising:
a first primary side switch configured to be switchable between an on state and an off state;
a second primary side switch configured to be switchable between the on state and the off state; and
an energy transfer element configured to transfer energy from the input voltage to the secondary side; and
a controller is configured to:
operate in a first control state, wherein the controller, whilst operating in the first control state, is configured to:
i) switch the first primary side switch to the on state for a first on time duration; and
ii) switch each of the first and second primary side switches to the off state for a first off time duration, after the first on time duration; and
operate in a second control state, wherein the controller, whilst operating in the second control state, is configured to:
i) switch the second primary side switch to the on state for a second on time duration; and
ii) switch each of the first and second primary side switches to the off state for a second off time duration, after the second on time duration.

23. A method of controlling a power converter for receiving an input voltage at a primary side and generating an output voltage at a secondary side, the power converter comprising:
a first primary side switch configured to be switchable between an on state and an off state;
a second primary side switch configured to be switchable between the on state and the off state; and
an energy transfer element configured to transfer energy from the input voltage to the secondary side; the method comprising:
operating a controller in a first control state by:
i) switching the first primary side switch to the on state for a first on time duration; and
ii) switching each of the first and second primary side switches to the off state for a first off time duration, after the first on time duration; and
operating the controller in a second control state by:
i) switching the second primary side switch to the on state for a second on time duration; and
ii) switching each of the first and second primary side switches to the off state for a second off time duration, after the second on time duration.
